(19) United States
(12) Patent Application Publication
(10) Pub. No.: US 2011/0085415 A1
(43) Pub. Date: Apr. 14, 2011

(54) METHOD FOR SYNCHRONIZING SEISMIC DATA RECORDED BY TWO OR MORE SEPARATE RECORDING SYSTEMS

(76) Inventors: Peter J. Morton, Katy, TX (US); David G. Fairservice, Castle Rock, CO (US)

(21) Appl. No.: 12/576,589

(22) Filed: Oct. 9, 2009

(51) Int. Cl. G01V 1/36; G01V 1/40

(52) U.S. Cl. 367/25; 367/40

(57) ABSTRACT

A method for synchronizing recordings of seismic sensor signals between at least two time indexed recording units includes cross-correlating signals recorded by each of a first and a second recording unit from a same reference sensor. The reference sensor is deployed proximate a subsurface volume to be evaluated and generates at least one of an optical and an electrical signal in response to seismic amplitude. Peaks in a power spectrum of the cross correlated signals are determined. The reference signals recorded by each of the first and second recording units are notch filtered using at least one notch frequency selected from the power spectrum. The notch filtered reference signals are cross correlated and a time offset between recordings made by the first recording unit and the second recording unit is determined from the cross-correlated, notch filtered signals.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic data measurement and recording. More specifically, the invention relates to techniques for synchronizing recordings made by two or more separate, unconnected seismic data recording systems.

2. Background Art

Seismic data measurement and recording known in the art includes deployment of an array of seismic sensors, such as geophones or accelerometers in a selected pattern proximate the Earth's surface above a volume of interest in the subsurface to be evaluated. The array of seismic sensors is ultimately coupled to a recording unit, which includes devices for making a time indexed record of the signals produced by each of the seismic sensors (although in some circumstances, certain groups of seismic sensors will be electrically coupled so that each group generates a single group signal).

It is also known in the art to deploy one or more seismic sensors in a wellbore drilled through subsurface rock formations proximate to the volume of interest in the subsurface. Typically, the seismic sensors are suspended at the end of an armored electrical cable. The cable may be deployed by a winch or similar spooling device known in the art. Signals generated by the sensors in the wellbore are typically transmitted along the cable to a recording unit at the Earth's surface.

In some types of seismic surveying, both surface deployed sensors and wellbore deployed sensors will be used to evaluate the same volume of the subsurface at the same time. In some examples, both surface sensors and wellbore sensors will have long duration recordings of their signals made for the purpose of detecting seismic events occurring within the subsurface volume, whether induced or naturally occurring. Such events are frequently referred to as “microseismic” events. In other examples, an active, controllable seismic source such as a vibrator or dynamite may be used. Irrespective of the seismic source used, it is necessary for purposes of evaluating the seismic signals recorded near the surface and within the wellbore that the signal recordings are properly synchronized. That is, each signal recording may be referenced to a common, known time or time difference.

There exists a need for techniques to synchronize seismic signal recordings made by two or more separate recording systems.

### SUMMARY OF THE INVENTION

A method according to one aspect of the invention for synchronizing recordings of seismic sensor signals between at least two time indexed recording units includes cross-correlating signals recorded by each of a first and a second recording unit from a same reference sensor. The reference sensor is deployed proximate a subsurface volume to be evaluated and generates at least one of an optical and an electrical signal in response to seismic amplitude. Peaks in a power spectrum of the cross correlated signals are determined. The reference signals recorded by each of the first and second recording units are notch filtered using at least one notch frequency selected from the power spectrum. The notch filtered reference signals are cross correlated and a time offset between recordings made by the first recording unit and the second recording unit is determined from the cross-correlated, notch filtered signals.

A method for seismic surveying according to another aspect of the invention includes deploying a first plurality of seismic sensors in a selected pattern above a subsurface volume to be evaluated and deploying a second plurality of seismic sensors in a wellbore drilled proximate the volume. Seismic signals generated by the first plurality of sensors are recorded in a first recording unit and seismic signals generated by the second plurality of sensors are recorded in a second recording unit. Signals generated by a reference seismic sensor disposed proximate the volume are recorded in both the first and the second recording units. The reference sensor signals recorded by each of the first recording unit and the second recording unit are cross-correlated. Peaks are determined in a power spectrum of the cross-correlated signals. The reference signals recorded by each of the first and second recording units are notch filtered using at least one notch frequency selected from the power spectrum. The notch filtered reference signals are cross-correlated. A time offset between recordings made by the first recording unit and the second recording unit is determined from the cross-correlated, notch filtered signals.

Other aspects and advantages of the invention will be apparent from the following description and the appended claims.

### BRIEF DESCRIPTION OF THE DRAWINGS

FIG. 1 is a schematic representation of a surface seismic sensor array and a wellbore seismic sensor array connected to respective recording systems.

FIG. 2 is a flowchart of one example of a method according to the invention.

FIG. 3A shows an example cross correlation between recordings of a reference sensor signal on two different recording systems . . . .

FIG. 3B shows an example cross correlation with a common seismic event visible therein.

FIG. 4 shows an example power spectrum of a cross correlation.

FIG. 5 shows the reference sensor signal recorded on the two recording systems after adjustment of the time difference between the recording systems.

### DETAILED DESCRIPTION

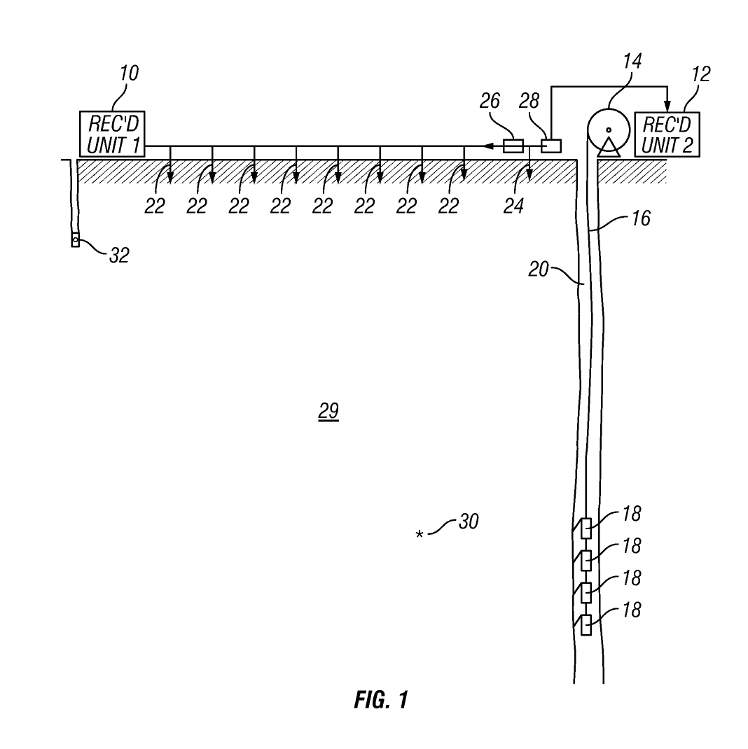

A typical arrangement of seismic acquisition equipment for evaluating a selected volume 29 of the subsurface is shown in FIG. 1. The arrangement shown in FIG. 1 includes seismic sensors 22 deployed proximate the Earth's surface (“surface sensors”) above the volume 29. The surface sensors 22 may be geophones, accelerometers, or multiaxial geophones or accelerometers, for example. The particular type of sensor used for the surface sensors 22 is not intended to limit the scope of the present invention. The surface sensors may be deployed in a selected geometric pattern above the volume 29 depending on the nature of the investigation into the volume 29. The surface sensors 22 may generate electrical or optical signals corresponding to seismic amplitude at any moment in time. The surface sensors 22 may be in signal communication with a first recording unit 10 deployed in a convenient location proximate the surface sensors 22.

A wellbore 20 may be drilled at a selected location into or through the subsurface proximate the volume 29. One or more seismic sensors 18 (“wellbore sensors”) may be deployed at selected depths in the wellbore 20. The wellbore sensors 18 may also be geophones, accelerometers or multiaxial geophones or accelerometers. As is the case for the surface sensors 22, the type of wellbore sensors 18 is not intended to limit the scope of the invention. The wellbore seismic sensors 18 are typically deployed at the end of an armored electrical cable 16, which may be extended into and withdrawn from the wellbore 20 using a winch 14 or similar spooling device known in the art. The wellbore seismic sensors 18 may generate electrical or optical signals representative of the seismic amplitude at any moment in time. Typically, the signals from the wellbore seismic sensors 18 will be communicated over the cable 16 to a second recording unit 12 deployed at the Earth's surface. The second recording 12 unit may make time indexed recordings of the signals produced by the wellbore sensors 18.

As explained in the Background section herein, it is desirable to synchronize the recordings made in the first recording unit 10 of the surface seismic sensor 22 signals to the recordings made in the second recording unit 12 of the wellbore seismic sensor 18 signals so that suitable evaluation from both sets of sensors may be made of certain phenomena in the volume 29, for example a microseismic event 30, or the energy emitted by an active seismic source 32, such as dynamite or a vibrator. Typically, the first recording system 10 and the second recording system 12 have no facility for signal communication therebetween. Thus, the invention is directed toward synchronizing seismic signals recorded on two or more such recording systems where there is no facility for intercommunication or other form of recording synchronization.

In the example of FIG. 1, a reference seismic sensor 24 may be deployed at a convenient location proximate the Earth's surface above the volume 29. The reference seismic sensor 24 may be a geophone or accelerometer, for example, although the type of sensor is not a limit on the scope of the present invention. The reference seismic sensor 24 may be in signal communication with a selected recording channel of the first recording unit 10, for example, through a first analog to digital converter 26. The reference seismic sensor 24 may be in signal communication with a selected recording channel of the second recording unit 12, for example, through a second analog to digital converter. Thus, in each of the first recording unit 10 and the second recording unit 12, respective recordings will be made of the output of the same seismic sensor, that is, the reference sensor 24. Therefore, irrespective of the time index allocated to the recording of the reference sensor 24 made in each of the first recording system 10 and the second recording system 12, the signal recordings represent the identical seismic amplitude with respect to absolute time.

In certain circumstances, seismic events would be of such a nature, for example, energy from an impulsive source such as dynamite, that the identical seismic event could be readily identified in each of the recordings (i.e., in the first and second recording units, respectively) from the reference seismic sensor 24. For example, amplitude threshold detection, or even visual observation, could identify a common seismic event of such nature, thus enabling determining a difference between the time record index of the first recording system 10 and the time record index of the second recording system 12. However, if a non-impulsive source such as a seismic vibrator is used as the seismic energy source, or if passive seismic signals (microseismic events) are being detected and evaluated, such techniques for identifying the same seismic event in both recordings of the reference sensor 24 become impracticable.

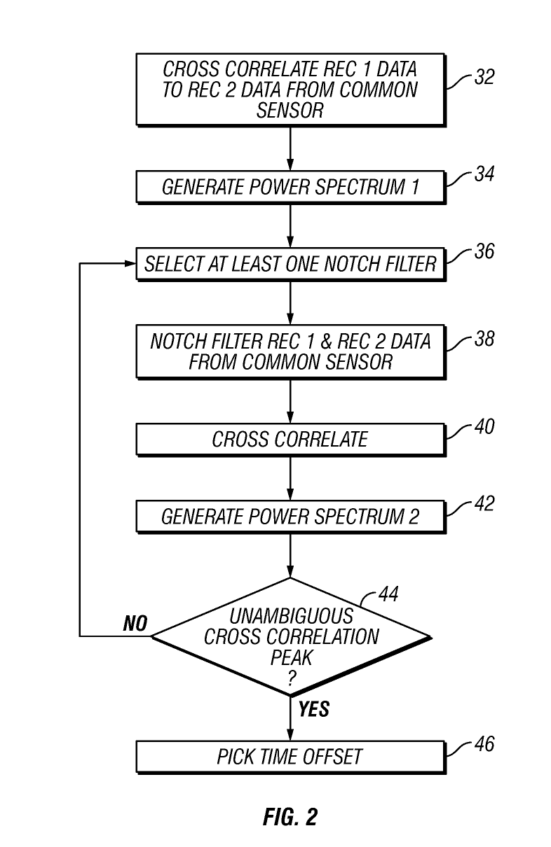

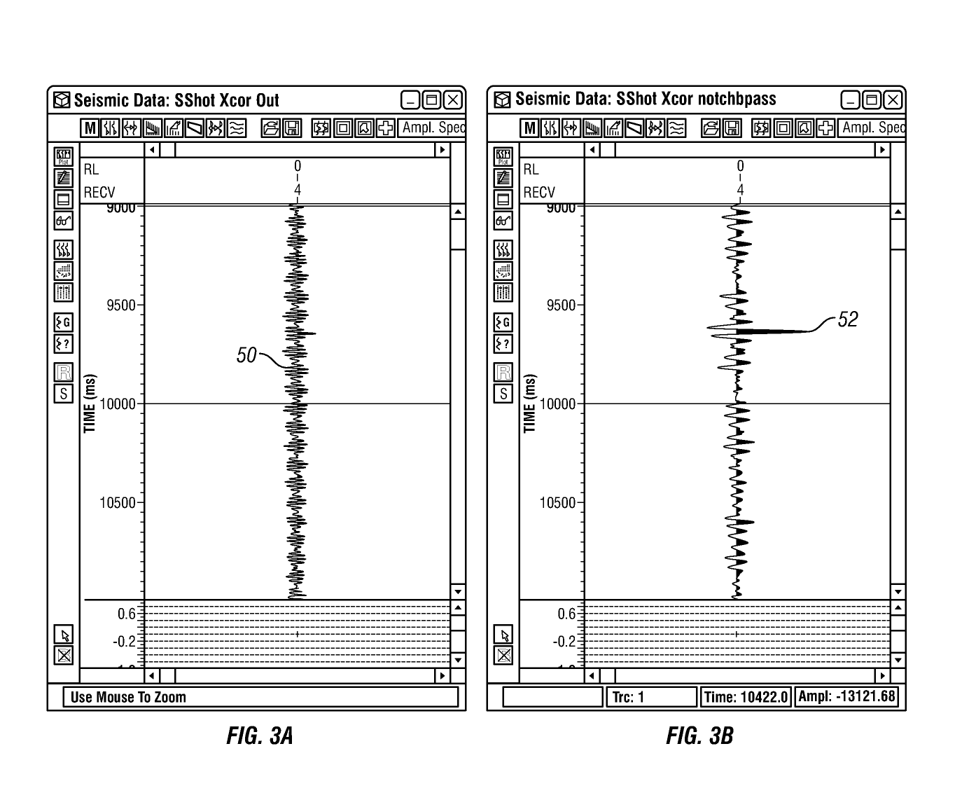

In a method according to the invention, and with reference to FIG. 2, at 32 the reference sensor signals recorded by the first recording unit (10 in FIG. 1) are cross correlated to the reference sensor signals recorded by the second recording unit (12 in FIG. 1). In some cases, a common seismic event can be determined after the first such cross correlation, and in such cases, the record index time in the first recording unit record may be compared to the record index time in the second recording unit record to determine the difference between the time indices (time offset) of the first and second recording units. Such difference or offset may be applied to the seismic sensor signals recorded in either the first or the second recording unit to synchronize all the seismic sensor recordings made by the respective recording units. An example of such cross correlation is shown in FIG. 3B and the event is visible at 52. The cross-correlation and related process elements described herein may be performed on any general purpose programmable computer. Such computer may be part of either or both of the first recording unit (10 in FIG. 1) and the second recording unit (12 in FIG. 1), or may be another computer located near or away from the recording site. A general purpose computer may be programmed to perform the foregoing and following process elements by reading instructions stored on a computer readable medium such as a CD-ROM, flash drive or hard drive, for example.

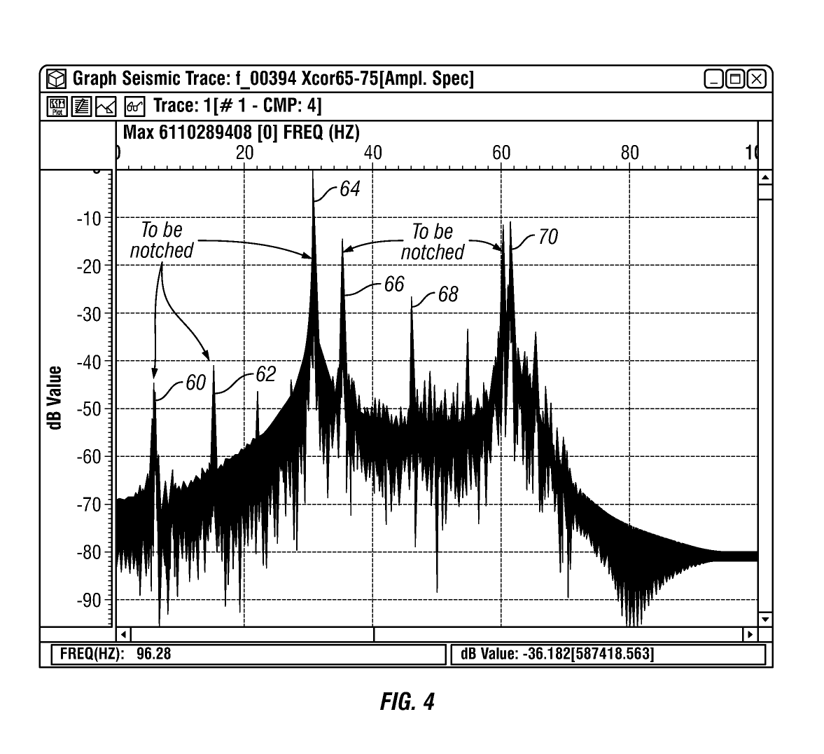

In other cases, a seismic event recorded in both recording units from the reference sensor may not be apparent after cross-correlation. One example of such cross-correlation is shown in FIG. 3A at 50. In such cases, in the present example a power spectrum of the cross-correlation may be determined or calculated. The power spectrum may be determined, for example, in the form of logarithm of amplitude with respect to frequency, or square of the amplitude with respect to frequency. Referring to FIG. 4, it has been observed that noise in the signal recordings manifests itself as distinct, substantially monochromatic peaks, shown at 62-70, in the power spectrum of the cross-correlation. Returning to FIG. 2, in the present example, at least one such peak is selected, and the frequency of the selected peak is used, at 36, to generate a notch filter.

At 38, the recording of the reference sensor signals made in the first recording unit and in the second recording unit are each filtered using the foregoing notch filter. After notch filtering, the cross-correlation may be repeated, at 40. At 42, a second power spectrum may be generated for the cross-correlated, notch filtered signals. At 44, 34). if a sufficiently unambiguous cross correlation is obtained, such peak in the second cross-correlation may then be used to identify the time difference or offset between the recording time index of the first recording unit and the second recording unit. This is shown at 46 in FIG. 2.

If at 44 an unambiguous cross correlation peak is not determinable, however, the process of selecting a peak at a particular frequency in the latest power spectrum generated, generating a corresponding notch filter, filtering the reference sensor recordings in both the first and second recording units, and cross-correlating the notch filtered signals may be repeated. The foregoing procedure may be repeated until an unambiguous cross-correlation peak becomes determinable, whereupon the cross-correlation peak may be used to identify the time offset, at 46, between the first recording unit (10 in FIG. 1) and the second recording unit (12 in FIG. 1).

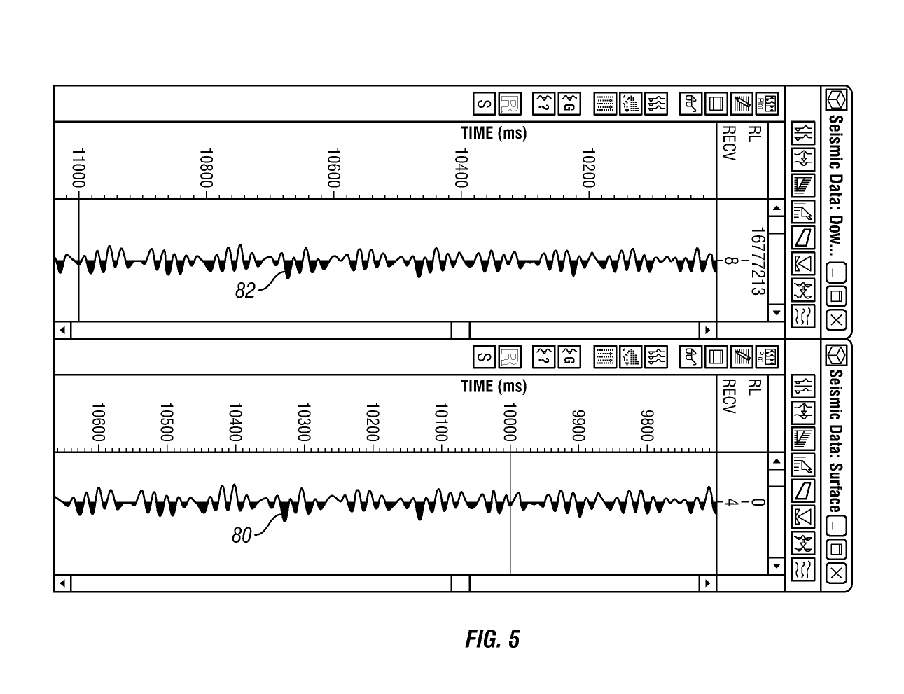

Referring to FIG. 5, once the time offset between the recording units has been determined, the time offset may be applied to all of the signal recordings of either recording unit. In FIG. 5, the signals recorded by the reference sensor (24 in FIG. 1) in the first recording unit are shown at curve 80, and the reference sensor signals recorded in the second recording unit with the determine time offset applied are shown at curve 82. If the time offset is correctly determined, similar features recorded by each recording unit in the reference sensor signals should be substantially time coincident.

Methods according to the invention may enable synchronization of time based sensor recordings in two or more recording units where it is impracticable to communicate a synchronization signal between the recording units. Although only two recording systems are shown herein and described, it is within the scope of the present invention to use the same technique to synchronize seismic data recording on three or more separate data recording systems.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for synchronizing recordings of seismic sensor signals between at least two time indexed recording units, comprising:
cross-correlating signals recorded by each of a first recording unit and a second recording unit from a same reference sensor, the reference sensor deployed proximate a subsurface volume to be evaluated and generating at least one of an optical and an electrical signal in response to seismic amplitude;
determining peaks in a power spectrum of the cross correlated signals;
notch filtering the reference signals recorded by each of the first and second recording units using at least one notch frequency selected from the power spectrum;
cross-correlating the notch filtered reference signals; and
determining a time offset between recordings made by the first recording unit and the second recording unit from the cross-correlated, notch filtered signals.

2. The method of claim 1 wherein if an unambiguous cross correlation peak is undeterminable in the cross-correlated, notch filtered signals, determining a power spectrum of the cross-correlated, notch filtered signals; and
repeating the selecting a peak in the power spectrum, notch filtering the notch-filtered reference signals and cross correlating the notch filtered signals until an unambiguous cross-correlation peak is determinable in the cross-correlated, notch-filtered signals.

3. The method of claim 1 further comprising applying the determined time offset to signal recordings made by at least one of the first and second recording units, the signal recordings comprising recordings of seismic signals generated by seismic sensors deployed proximate the subsurface volume, the seismic sensors generating at least one of electrical and optical signals corresponding to seismic amplitude.

4. The method of claim 3 wherein the seismic sensors are deployed in a selected pattern proximate the Earth's surface.

5. The method of claim 3 wherein the seismic sensors are deployed in a wellbore drilled proximate the subsurface volume.

6. The method of claim 3 wherein seismic events occurring within the volume are detected.

7. The method of claim 3 wherein seismic events corresponding to actuation of a controlled seismic source are detected.

8. A method for seismic surveying, comprising:
deploying a first plurality of seismic sensors in a selected pattern above a subsurface volume to be evaluated;
deploying a second plurality of seismic sensors in a wellbore drilled proximate the volume;
recording seismic signals generated by the first plurality of sensors in a first recording unit;
recording seismic signals generated by the second plurality of sensors in a second recording unit;
recording signals generated by a reference seismic sensor disposed proximate the volume in both the first and the second recording units;
cross-correlating the reference sensor signals recorded by each of the first recording unit and the second recording unit;
determining peaks in a power spectrum of the cross-correlated signals;
notch filtering the reference signals recorded by each of the first and second recording units using at least one notch frequency selected from the power spectrum;
cross-correlating the notch filtered reference signals; and
determining a time offset between recordings made by the first recording unit and the second recording unit from the cross-correlated, notch filtered signals.

9. The method of claim 8 wherein if an unambiguous cross correlation peak is undeterminable in the cross-correlated, notch filtered signals, determining a power spectrum of the cross-correlated, notch filtered signals and repeating the selecting a peak in the power spectrum, notch filtering the notch-filtered reference signals and cross correlating the notch filtered signals until an unambiguous cross-correlation peak is determinable in the cross-correlated, notch-filtered signals.

10. The method of claim 8 further comprising applying the determined time offset to signal recordings made by at least one of the first and second recording units.

11. The method of claim 8 wherein seismic events occurring within the volume are detected.

12. The method of claim 8 wherein seismic events corresponding to actuation of a controlled seismic source are detected.
